(19) United States
(12) Patent Application Publication
(10) Pub. No.: US 2002/0063398 A1
(43) Pub. Date: May 30, 2002

(54) Seal for pressure vessels

(76) Inventor: Christopher M. Norman-Martin, Maple Ridge (CA)

Correspondence Address: Attention: Natan Epstein, BEEHLER & PAVITT, Suite 330, 100 Corporate Pointe, Culver City, CA, 90230, US

(21) Appl. No.: 09/859,226

(22) Filed: May 15, 2001

(30) Foreign Application Priority Data
Nov. 24, 2000 (CA) 2,326,858

(51) Int. Cl. F16J 15/02; F16J 15/46

(52) U.S. Cl. 277/646

(57) ABSTRACT

A improved seal for a outwardly opening door in a pressure vessel is achieved by providing an elastic inflatable tube in a groove between opposed facing surfaces rigidly associated with the door and with the vessel chamber. The groove and tube completely surround the opening of the chamber in a closed fashion. Clamps are provided to retain the door on the chamber. After the door is closed, the tube is inflated to a pressure at least equal to the pressure in the chamber and sufficient to cause the tube to fill any gaps caused by distortion of the door under the effect of the outward pressure from the chamber.

### FIELD OF THE INVENTION

This invention relates to a sealing system for pressure vessels. More particularly, this invention relates to an improved seal for outwardly opening doors or hatches in high pressure vessels.

### BACKGROUND OF THE INVENTION

In vessels designed to contain relatively high pressures, it is common to provide inwardly opening doors where possible. The outward pressure acts to urge the door closed, thereby facilitating the establishment of a seal between the door and the vessel walls, or the door frame.

However in certain cases, the use of inwardly opening doors is impractical. For example, in the case of already large hyperbaric chambers used for humans or larger mammals, an inwardly opening door would further increase the overall size of the chamber to accommodate movement of the door when the subject is inside the chamber. In such cases, outwardly opening doors are provided. But the pressure exerted on outwardly opening doors often causes significant distortion of the door and consequent loss of seal. In the prior art, this is typically addressed by a plurality of large and cumbersome clamps that are provided about the periphery of the door. Despite this, it has still been difficult to maintain tight seals in view of the high pressures involved.

It is an object of the present invention to provide an improved seal for outwardly opening doors or hatches of high pressure vessels that overcomes the foregoing deficiencies.

### SUMMARY OF THE INVENTION

In one aspect, the invention comprises an inflatable elastic tube disposed between a first surface rigidly associated with an outwardly opening door of a pressure vessel and a second surface rigidly associated with the opening to the chamber of the vessel.

In other aspects of the invention, the tube is endless, is disposed to completely encircle said opening, and is seated in a groove in one of the surfaces.

In another aspect of the invention, the tube substantially completely fills the groove and abuts against the other of the surfaces when the tube is inflated.

In another aspect of the invention, an inflation spout is in communication with the interior of the tube and extends to a source of hydraulic or pneumatic pressure.

In another aspect of the invention, the spout is disposed in a channel extending from the groove.

In yet another aspect of the invention, at least one clamp retains the first and second surfaces in a proximal relationship.

In a further aspect of the invention, the first surface is defined on a flange extending from the door and the second surface is defined on a flange extending from the chamber, and at least one clamp retains the flanges in a proximal relationship.

In a further aspect of the invention, the first surface is defined on a flange extending from the door and the second surface is defined on a flange extending from the chamber, at least one clamp retains the flanges in a proximal relationship, and an inflation spout is disposed in a channel extending from the groove, the spout being in communication with the interior of the tube and extending to a source of hydraulic or pneumatic pressure.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is an end view of the door and support ring of a pressure vessel;

FIG. 2 is a side view of a pressure vessel including a seal according to the preferred embodiment of the invention;

FIG. 3 is a sectional view along line A-A of FIG. 2;

FIG. 4 is a sectional view along line B-B of FIG. 2 with the tube deflated;

FIG. 5 is a sectional view along line B-B of FIG. 2 with the tube inflated;

FIG. 6 is a sectional view of the support rings and tube in the vicinity of one of the clamps with the tube deflated; and, FIG. 7 is a sectional view of the support rings and tube in the vicinity of one of the clamps with the tube inflated.

### DETAILED DESCRIPTION OF THE PREFERRED EMBODIMENT

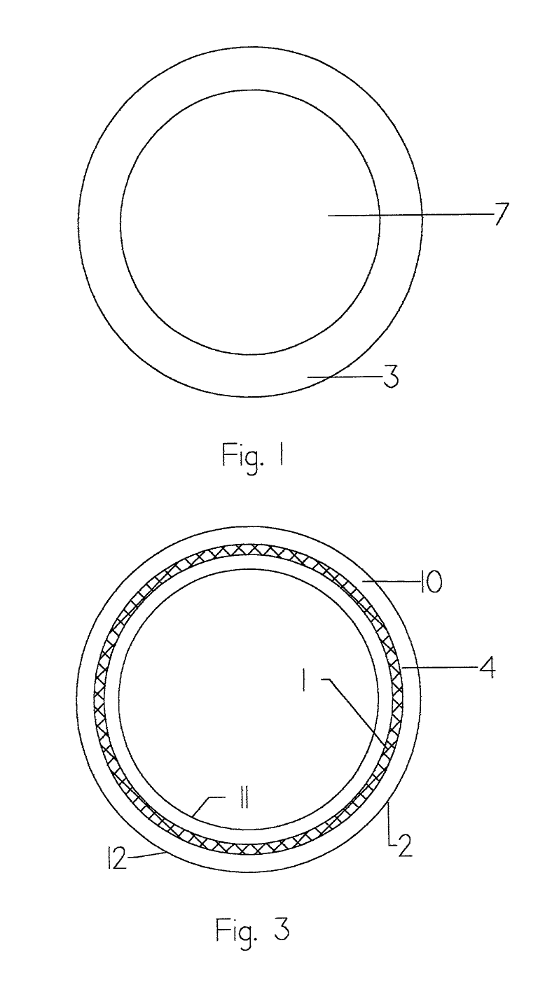

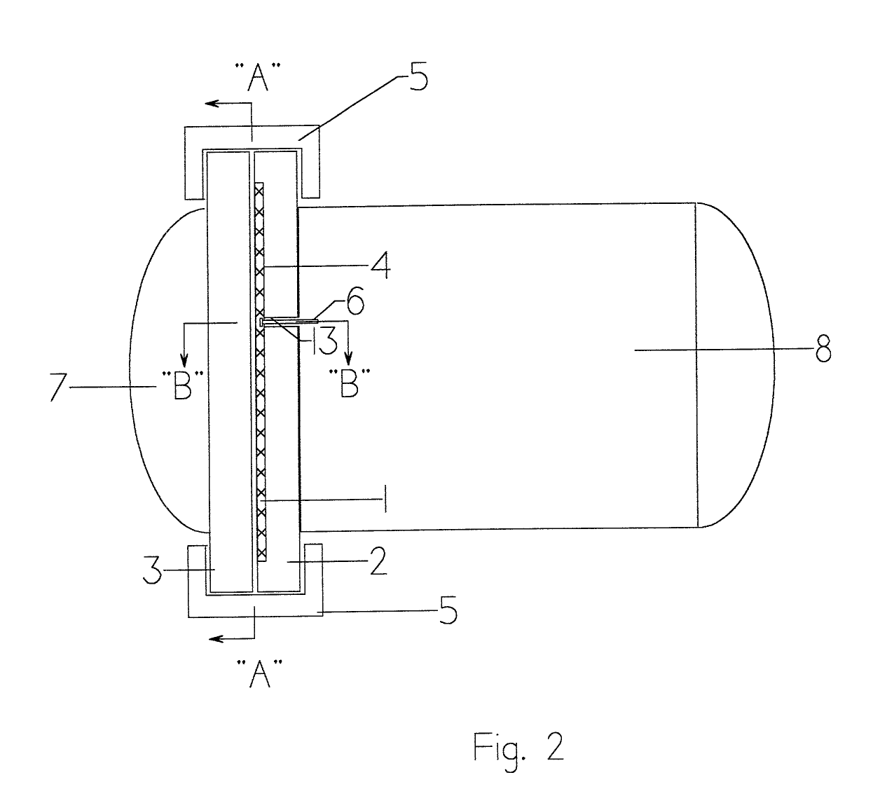

Referring to FIG. 2, a door or hatch 7 is provided to close an opening (not shown) in a pressure chamber 8. Door 7 is hinged and configured to open outwardly. In the preferred embodiment, the door is circular as is best appreciated by reference to FIG. 1.

A support ring 3 is rigidly welded about the rim of the door 7. A corresponding support ring 2 is rigidly welded about the rim of the opening to the chamber 8. Support rings 2 and 3 are provided with faces 9, 10 that have similar shapes and dimensions so as to be brought into mutually facing relationship when the door 7 is closed.

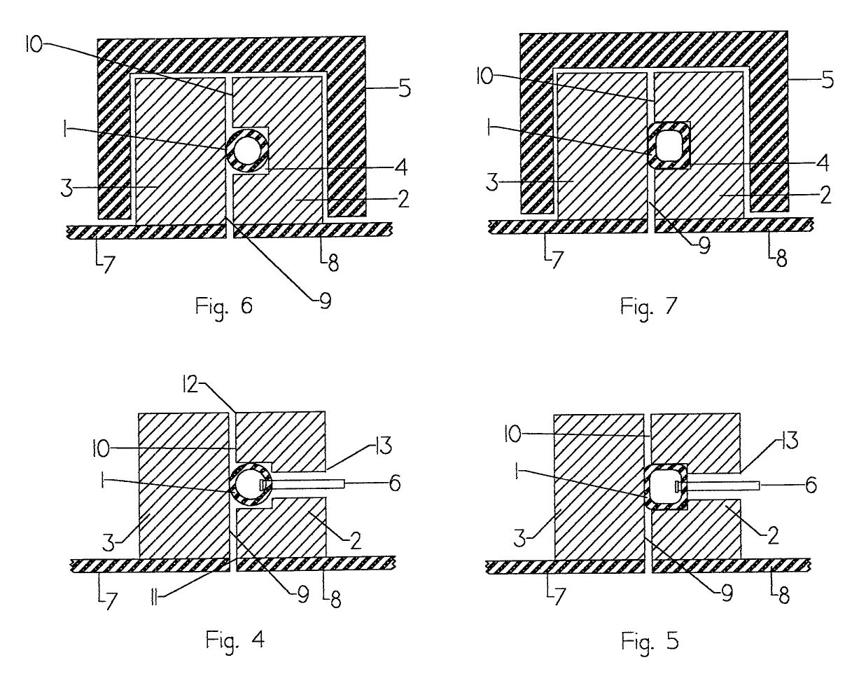

A continuous groove or dado 4 is machined in the face 10 of support ring 2 to completely surround the opening of the chamber. Referring to FIG. 4, face 10 extends between a first edge 11 and a second edge 12 of face 10. Groove 4 is spaced from each of edges 11 and 12. Preferably, groove 4 is equally spaced from each edge.

An endless inflatable hollow tube 1 is seated in groove 4 throughout its extent to as to encircle the opening of the chamber 8. Tube 1 is made of an elastic material suitable for the pressures and forces corresponding to the rating of the pressure vessel. The elasticity of the tube allows it to conform to the shape of the surfaces containing it when is the tube is inflated. Tube 1 may be of a variety of sizes and shapes but is preferably of such a size and shape that it will loosely fill groove 4 when tube 1 is deflated and will substantially completely fill it and push outward of the groove when it is inflated.

A channel 13 is machined to extend from groove 4 to the outer edge of support ring 2, as best illustrated in FIG. 2. Channel 13 is of a diameter that is smaller than the diameter of the tube 1, whether inflated or deflated.

A spout 6 extends through channel 13 to communicate with the interior of tube 1. The outside end of spout 6 is connected to a pneumatic or hydraulic pressure source (not shown) to allow selective inflation or deflation of the tube by means of a suitable gas or liquid. In the preferred embodiment, nitrogen gas is used.

Rigid U-shaped clamps 5 are provided to snugly abut against the outside of support rings 2 and 3 when the door 7 is closed and tube 1 is deflated. The number and shape of clamps 5 may vary according to the dimensions of the support rings and the pressure rating of the vessel.

In use, door 7 is closed so that faces 9 and 10 are brought into facing relationship. This is done when tube 1 is deflated. Once the door is closed, clamps 5 are applied. Spout 6 is then used to inflate tube 1 to a pressure that is substantially greater (e.g. 5 times in a large hyperbaric chamber) than the intended pressure within chamber 8. Tube 1 will therefore expand to substantially completely fill groove 4 and to press against face 9. This creates a seal around door 7 between the support rings 2 and 3. While outward pressure on door 7 may tend to displace it outwardly and to distort it (particularly in the areas where there is no clamp 5), elastic tube 1 will act to compensate by filling any gaps that may occur as a result of the distortion.

In the case of smaller pressure vessels, or vessels operating at lower pressures, it may be sufficient to have a tube pressure that is more approximately equal to the intended pressure inside the chamber. This is because for smaller vessels or lower pressures, the distortion of the door is minimized and therefore the gaps to be filled by the tube are less prominent.

At the end of the cycle, pressure in the chamber 8 is reduced and tube 1 is deflated using spout 6. Deflating tube 1 relaxes the seal so that if there is residual excess pressure within the chamber, it is released through any permanent small gaps or any distortion-induced gaps there may be between faces 9 and 10. Clamps 5 are then removed, and the door may be opened. The system of the invention also provides a means of quickly releasing the pressure within the vessel in an emergency.

The invention therefore provides an effective means of sealing the door and of compensating for any permanent gaps or distortion-induced gaps created by outward pressure on the door. This in turn allows for smaller and less elaborate clamping and closing mechanisms, and for less stringent tolerances of the mating surfaces 9 and 10.

In the preferred embodiment, the support rings 2 and 3 and the clamps 5 are rectangular in cross section. However a variety of shapes are effective, provided the two facing surfaces or faces of the support rings are complementary and that a groove may be machined in one of the surfaces.

The groove 4 may be provided in either of support rings 2 or 3 with equal effect. However providing it in the support ring of the door may result in unnecessary interference with the pressure supply lines to spout 6 when the door is being opened or closed. It is therefore preferable to machine groove 4 in the support ring that is rigidly associated with the stationary chamber 8.

The shape of groove 4 has been illustrated as rectangular. However, it may be of any suitable shape. However, the shape must be such that it allows the inflated tube to abut outward of the groove toward the face of the opposing support ring.

The shape of the door 7 need also not be circular, although circular doors are preferred for high pressure vessels. Alternate shapes are within the scope of the invention, provided the tube is so shaped that it can accommodate any changes in the direction of the groove and that it will effectively seal any areas of the groove that may be particularly susceptible to gapping.

The support rings need not necessarily be of the same shape as the perimeter of the door. For example, the invention accommodates a circular support ring rigidly attached to a door that closes a square opening to the chamber. This facilitates the use of a ramp or other means of providing convenient access to the interior of the chamber.

It will be appreciated that other modifications to the preferred embodiment may be practised without departing from the scope of the invention.

1. Apparatus for establishing a seal between an opening in a pressure chamber and a door opening outwardly from said opening, comprising an inflatable elastic tube disposed between a first surface rigidly associated with said door and a second surface rigidly associated with said opening.

2. Apparatus as in claim 1 wherein said tube is endless and is disposed to completely encircle said opening.

3. Apparatus as in claim 2 wherein said tube is seated in a groove in one of said surfaces.

4. Apparatus as in claim 3 wherein said tube substantially completely fills said groove and abuts against the other of said surfaces when said tube is inflated.

5. Apparatus as in claim 4 further comprising an inflation spout in communication with the interior of said tube and extending from said interior to a source of hydraulic or pneumatic pressure.

6. Apparatus as in claim 5 wherein said spout is disposed in a channel extending from said groove.

7. Apparatus as in claim 2 or 4 further comprising at least one clamp for retaining said first and second surfaces in a proximal relationship.

8. Apparatus as in claim 2 or 4 wherein said first surface is defined on a flange extending from said door and said second surface is defined on a flange extending from said chamber, said apparatus further comprising at least one clamp for retaining said flanges in a proximal relationship.

9. Apparatus as in claim 2 or 4 wherein said first surface is defined on a flange extending from said door and said second surface is defined on a flange extending from said chamber, said apparatus further comprising at least one clamp for retaining said flanges in a proximal relationship, and an inflation spout disposed in a channel extending from said groove, said spout being in communication with the interior of said tube and extending from said interior to a source of hydraulic or pneumatic pressure.

10. A method of establishing a seal between an opening in a pressure chamber and a door opening outwardly from said opening comprising:
providing an elastic inflatable tube disposed between a first surface rigidly associated with said door and a second surface rigidly associated with said opening;
closing said door such that said first and second surfaces are in facing relationship; and,
inflating said tube to a pressure at least equal to the pressure inside said chamber.

11. A method as in claim 10 wherein said tube is endless and is disposed to completely encircle said opening.

12. A method as in claim 11 wherein said tube is seated in a groove in one of said surfaces.

13. A method as in claim 12 wherein said tube substantially completely fills said groove and abuts against the other of said surfaces when said tube is inflated.

14. A method as in claim 13 wherein said step of inflating said tube is performed using an inflation spout disposed in a channel extending from said groove, said spout being in communication with the interior of said tube and extending from said interior to a source of hydraulic or pneumatic pressure.

15. A method as in claim 10 or 14 further comprising the step of securing at least one clamp about said first and second surfaces to retain them in a proximal relationship.

16. A method as in claim 10, 11, 12, 13 or 14 wherein the tube is inflated to a pressure at least equal to the pressure in the chamber and sufficient to cause the tube to fill any gaps caused by distortion of the door under the effect of the outward pressure from the chamber.

17. A method as in claim 10, 11, 12, 13 or 14 further comprising the step of securing at least one clamp about said first and second surfaces to retain them in a proximal relationship, and wherein the tube is inflated to a pressure at least equal to the pressure in the chamber and sufficient to cause the tube to fill any gaps caused by distortion of the door under the effect of the outward pressure from the chamber.
